(19) United States
(12) Patent Application Publication
(10) Pub. No.: US 2005/0198064 A1
(43) Pub. Date: Sep. 8, 2005

(54) Method and apparatus for validating propagation of XML constraints to relations

(76) Inventors: Susan B. Davidson, Gladwyne, PA (US); Wenfei Fan, Somerset, NJ (US); Carmem Hara, Curitiba-PR (BR); Jing Qin, Elkins Park, PA (US)

Correspondence Address: MOSER, PATTERSON & SHERIDAN, LLP/;LUCENT TECHNOLOGIES, INC, 595 SHREWSBURY AVENUE, SHREWSBURY, NJ, 07702, US

(21) Appl. No.: 10/794,170

(22) Filed: Mar. 5, 2004

(51) Int. Cl. G06F 7/00

(52) U.S. Cl. 707/103 R

(57) ABSTRACT

Method and apparatus for validating propagation of XML constraints to functional dependencies when transforming XML to relational data. The method includes steps of accepting variables indicative of XML-based data, determining if one of the variables is unique based on checking the validity of XML keys defining XML constraints and determining if one or more fields in said relational data do not have a null value. The variables are selected from a set of XML keys (Σ), a transformation Rule (R) and a Functional Dependency (φ). One determining step includes substeps of viewing a transformation Rule as a Table Tree and traversing nodes in the Table Tree. The nodes are traversed until an XML key is found at a particular node and then said one of said plurality of variables (in one embodiment identified as x) is determined to be unique when compared to the context of said XML key.

### FIELD OF INVENTION

The invention relates to the field of XML usage and, more specifically, to validating the propagation of XML key-type information into relational databases.

### BACKGROUND OF INVENTION

A database is defined as a usually large collection of data organized especially for rapid search and retrieval. Typically the search and retrieval operations are performed by a computer for ease in handling the data. Relational (or type) data had been used almost exclusively with databases because such data is easily collected and understood by the database user and/or designer. As more and more data is becoming available in XML, and database research focus is shifting from the traditional relational model to semi-structured data and XML, it is important to understand new issues that arise when using XML.

One such issue is the semantics of XML data specifications. XML structures data in one form and relational data is structured in a different form. Therefore, a translation (or transformation) operation is necessary to move from one type of data to another (such as when importing/exporting XML data into/out of a relational database). Such translation operation usually does not include translation of constraints that are placed on the XML data. In other words, XML-based constraints (or keys) have equivalent relational constraints that establish relationships between the different fields of data. However, since the propagation of the XML constraints during translation is not computed, there is no way of knowing if XML data that is being imported is compatible with the database.

### SUMMARY OF THE INVENTION

The disadvantages heretofore associated with the prior art are overcome by a novel method and apparatus for validating the propagation of XML constraints to functional dependencies when transforming XML to relational data. The method includes the steps of (a) accepting variables indicative of XML-based data, (b) determining if one of the variables is unique based on checking the validity of XML keys defining XML constraints and (c) determining if one or more fields in said relational data do not have a null value. The variables are selected from the group consisting of a set of XML keys (Σ), a transformation Rule (R) and a Functional Dependency (FD), where the transformation Rule (R) includes an attribute I that corresponds to a value x.

Determining step (b) includes substeps of viewing a transformation Rule as a Table Tree and traversing nodes in the Table Tree. The nodes are traversed until an XML key is found at a particular node and then one of the variables (in one embodiment identified as x) is determined to be unique when compared to the context of said XML key. Determining step (c) includes substeps of viewing a transformation Rule as a Table Tree, traversing nodes in the Table Tree and deleting attributes from a set of all attributes that are required to exist as they are found at a particular node when traversing the nodes. The invention also includes an apparatus in the form of a computer readable medium containing instructions for operating a computer in accordance with the method steps presented. Accordingly, the invention provides for an improvement in the exchange of information between data from two different data types that exist within a single database. Validated XML constraint information means that the function dependencies that constrain the relational data is accurate and in harmony with the design and construction of the database.

### BRIEF DESCRIPTION OF THE DRAWINGS

The teachings of the present invention can be readily understood by considering the following detailed description in conjunction with the accompanying drawings, in which:

FIG. 1 depicts a series of method steps for checking the validity of propagation of XML key constraints in accordance with one embodiment of the subject invention;

FIG. 2 depicts a series of method steps detailing the step of determining the uniqueness of a variable of FIG. 1;

FIG. 3 depicts series of method steps detailing the step of checking for non-null fields of FIG. 1;

FIG. 4 depicts a series of method steps for determining a minimum cover of FDs propagated through XML keys in accordance with one embodiment of the subject invention;

FIG. 5 depicts a series of method steps detailing the step of generating the set of FDs of FIG. 4;

FIG. 6 depicts an apparatus operating in accordance with the subject invention; and

FIGS. 7a and b depict graphs of processing performance of the methods steps of the subject invention.

To facilitate understanding, identical reference numerals have been used, where possible, to designate identical elements that are common to the figures.

### DETAILED DESCRIPTION OF THE INVENTION

The subject invention provides methods for checking the validity of XML constraints in relational databases and computing a minimum cover of functional dependencies generated from XML keys. That is, if these given XML keys hold on the data being imported, then a functional dependency (FD) is guaranteed to hold on the relational database that stores the data. In such a case, the FD is identified as one that is propagated from these XML keys.

In general, given a transformation to a predefined relational schema and a set Σ of XML keys, one wants to know whether or not an FD is propagated from Σ via the transformation. This problem is referred to as XML key propagation. The ability to compute XML key propagation is important in checking the consistency of a predefined relational schema for storing XML data.

On the other hand, a relational database can be designed from scratch or can be re-designed to fit the constraints (and thus preserve the semantics) of the data being imported. A common approach to designing a relational database is to start with a rough schema and refine it into a normal form (such as BCNF or 3NF) using FDs. In this disclosure, it is assumed that the database designer specifies the rough schema by a mapping from the XML document. The FDs over that rough schema must then be inferred from the keys of the XML document using the mapping. However, it is impractical to compute the set F of all the FDs propagated since F is exponentially large in the number of attributes. Therefore, it is desirable to find a minimum cover of F, that is, a subset Fm of F that is equivalent to F (i.e., all the FDs of Fm can be derived from Fm using Armstrong's Axioms) and is non-redundant (i.e., none of the FDs in Fm can be derived from other FDs in Fm).

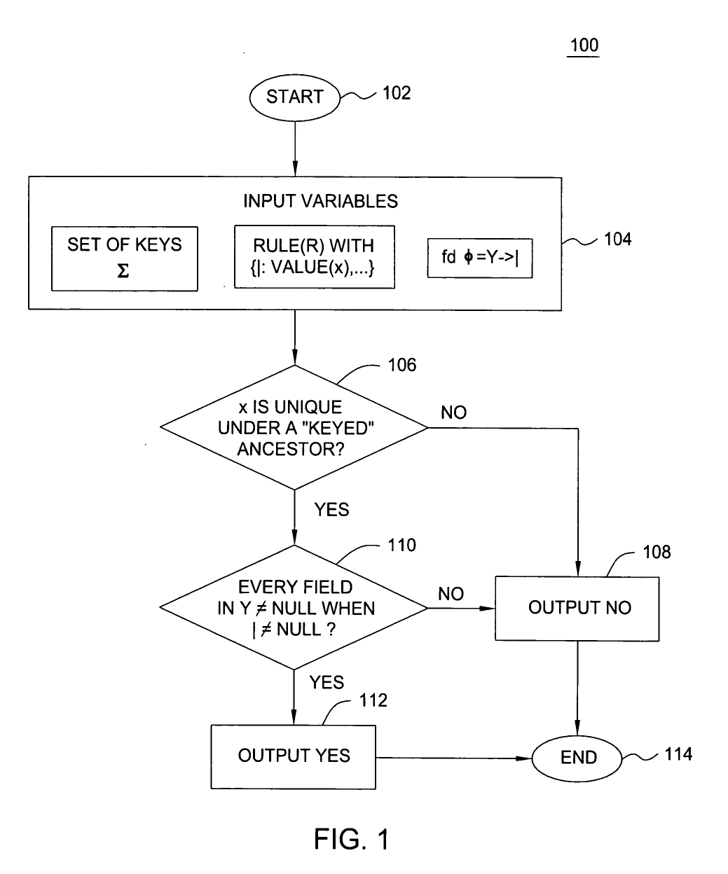

FIG. 1 depicts a series of method steps 100 for checking the validity of propagation of XML key constraints. Specifically, the method 100 starts at step 102 and proceeds to step 104 whereby variables are input into an algorithm Propagation. These variables are XML-related variables; hence, provide the basis of XML-based determinations of valid constraint propagation. In one embodiment of the invention, the variables are selected from the group consisting of a set of XML keys (Σ), a transformation Rule (R) and a Functional Dependency (φ). A key in the set of keys takes the form of (C, (T, {Al, . . . . Ak})), where C and T are the Context and Target path expressions, respectively, and Al, . . . , Ak are key paths. The transformation Rule generally takes the form of:
{I: value (x), . . . }, x<-path_expression, . . .
where I is the name of a field in the relational table or database and
x is a variable assigned to a node in the XML document reached by following a given path expression.
   Rule (R) is the operation by which XML is transformed into relational data. That is, the value (x) is transformed by virtue of Rule (R) and the results of the transformation populate the field I of the relational table thereby establishing a correspondence between the two types of data. The Functional Dependency φ generally takes the form:
   φ=Y→I
   where Y is a value of a set of attributes and
I a value of a single attribute.
   That is, the value of Y determines the value of I.

After the variables are input, the method proceeds to step 106 whereby a decision is made as to whether x is unique under a “keyed” ancestor in the Table Tree. Specifically, transformation rules, such as Rule (R), can be represented by a tree. The tree is upside down since the root is at the top of the tree and an increasing number of nodes expand outward therefrom. Starting from any node in the tree, each node thereabove along the single path to the root is identified as its ancestor. Some of these nodes have variables assigned to them. The values of these variables will populate some attributes of the relational database. For example, the value x will populate 1. The term “keyed” ancestor means that there is a set of XML keys that determines uniquely the identity of its ancestor. If an ancestor is keyed, it also means that only attributes of Y are involved in these keys that identify the ancestor (node). Therefore, it is offered that a FD is valid if I is checked for uniqueness at that particular ancestor. This can be asserted because there are two conditions that are necessary for a FD to be propagated from a set of XML keys: (1) there is an ancestor with a key (which in turn defines the value of Y) and (2) the value of I is unique under that ancestor.

If x is not unique, the method proceeds to step 108 where an output value of “No” for the overall decision of whether the XML constraints have been properly propagated to the relational data is made.

If x is unique, the method proceeds to step 110 where a second decision is made. Specifically, the method queries as to whether each field in the set of attributes Y that have value different from null when the attribute I is not null. The classic definition of a FD provides that if two lines of table data agree on the value of Y, then they must also agree on the value of I. However, when translating XML data to relational data, there may be occurrences of null values in the relational table (i.e., some fields are not populated as a result of the translation). Null values create “unknown” values that cannot be otherwise compared to see if the FD is valid; therefore, the classic definition is no longer compatible with the subject method. To account for this condition, the subject invention provides for a new definition of a FD which states that a FD is valid whenever Y contains a null value, then I is also null.

If the query is answered positively, then the two criteria for assuring propagation of XML constraints have been satisfied, and the method proceeds to step 112 to output a value of “Yes”. If the query is answered negatively, there are null values in the relational table that prevents propagation to be confirmed. As such, the method moves to step 108 to output a value of “No”. At any occurrence of step 108, the method then ends at step 114.

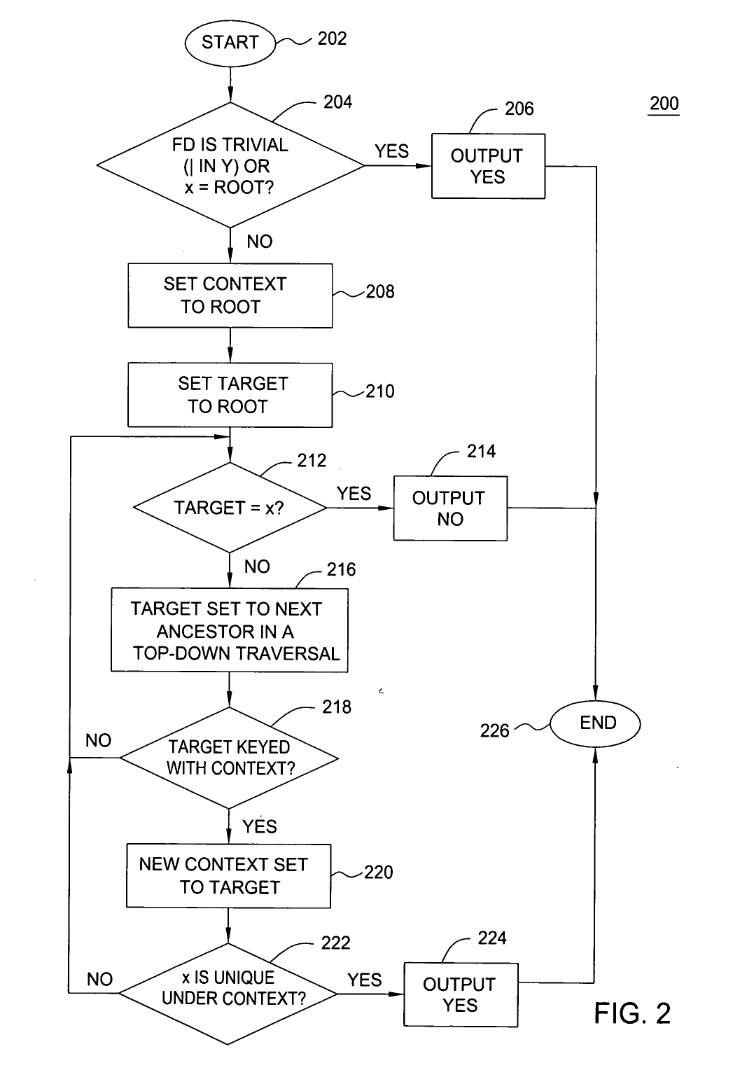

FIG. 2 depicts a series of method steps 200 that details how step 106 of method 100 is performed. The method starts at step 202 and proceeds to step 204 where a first decision is made. Specifically, the method 200 queries as to whether the FD is trivial or if the value x is the root of the Table Tree (discussed earlier). For sake of clarity, a FD is considered trivial if the value of I is an element of Y. If either of these conditions is true, then x is considered unique at this point and the method 200 proceeds to step 206 to output a value of “Yes” for decision step 106 of method 100. The method then ends at Step 226.

If neither of the above conditions are true, the method begins a node by node traversal of the Table Tree starting from the root towards x by first proceeding to steps 208 and 210 whereby variables Context and Target are set to the root of the Table Tree. Target represents the specific location (or node) that is being searched at a given time and Context represents the last node visited that has a key. At step 212, a second decision is made as to whether the target node being evaluated is in fact the searched-for node x. If this query is answered positively, the search is concluded (with no ancestors having been found with a key and x not having been found unique) and proceeds to step 214 to output a value of “No” to step 106 of method 100. The method then ends at step 226.

If the query is answered negatively, the method proceeds to step 216 whereby the Target variable is set to the next node (ancestor) as the search continues in a top-down pattern. At step 218, a third decision is made as to whether Target is keyed with respect to Context. If the answer to this query is negative, the method 200 loops back up to step 212 and continues with the top-down search pattern. If the answer to the query is positive, then this new value of Context is set to Target at step 220 (i.e., a key for the current node has been found).

After step 220, the method 200 proceeds to step 222 whereby a fourth decision is made. Specifically, the decision is whether the value x is unique under Context. In other words, to determine whether by following the path from Context to x in any XML document that satisfies the input set of XML keys, a single node corresponding to x is reached, thus validating a given FD. If x is not found to be unique, the method loops back to step 212 to continue with the top-down search. If the value of x is found to be unique, the method proceeds to step 224 where a value of “Yes” is provided for decision step 106 of method 100. The method 200 then ends at step 226.

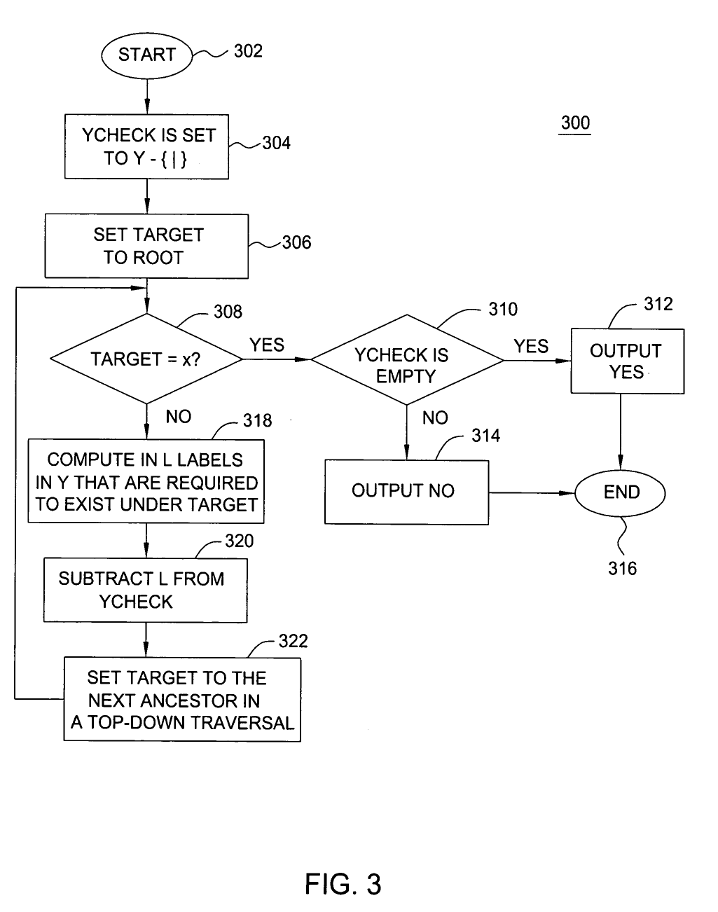

FIG. 3 depicts a series of method steps 300 that details how step 110 of method 100 is performed. In general, for any given XML key, there is a Context Path, a Target Path and a set of Key Paths. For an XML key to be valid, all the Key Paths must exist in the XML document. This information is exploited by checking that all attributes of Y exist whenever I exists. This is the only way to confirm that none of the Y attributes have a null value. The method starts at step 302 and proceeds to step 304 where a variable Ycheck is set to a value Y-I. That is, Ycheck is a list of all attributes that must be checked for non-null values. The method 300 then proceeds to step 306 which, similar to step 206 of method 200, sets the variable Target to the root of the Table Tree as a search for all the attributes in Ycheck is initiated.

At step 308, a first decision is made as to whether the target node being evaluated is in fact the searched-for value x. If this query is answered negatively, then the method proceeds to step 318 whereby a computation is performed. Specifically, all the XML keys are checked to see what attributes of Y need to exist at Target and labels L are computed based on this information. At step 320, the Label L is subtracted from Ycheck to remove these attributes from the list of items to be checked for non-null value. At step 322, the value of Target is set to the next ancestor (node) in a top-down traversal of a path in the Table Tree. Accordingly, the method 300 loops back to step 308 where the next node is evaluated in the manner described above.

If the query of step 308 is answered positively, the search is concluded and proceeds to step 310 where a decision is made as to whether Ycheck is empty. If Ycheck is empty, then all attributes of Y are accounted for and the method 300 proceeds to step 312 to output a value of “Yes” in step 110 of method 100. If Ycheck is not empty, then the method 300 proceeds to step 314 to output a value of “No” to step 110 of method 100. The method then ends at step 316 from either step 312 or 314.

Also included in the subject invention is a method for determining the minimum cover for FDs propagated from a given set of XML keys. As described earlier, it is too mathematically intensive to calculate all of the FDs (F) propagated from a given set of XML keys because F increases exponentially with the number of attributes in the relational table that stores the XML document. As such, an algorithm is disclosed to determine a minimum cover Fm of F. Such minimum cover is equivalent to F in that all FDs of F can be easily derived from Fm and non-redundant in that none of the other FDs in Fm can be derived from another FDs in Fm. In general, recall that the transformation Rule (R) can be depicted as a table tree, in which each variable x in the set of X of Rule (R) is represented by a unique node, referred to as the x-node. The algorithm traverses the tree top-down starting from the root and generates a set of FDs that is a cover of all possible FDs. More specifically, at each x-node encountered, it expands F by including certain FDs propagated from Σ. It then removes redundant FDs from F to produce a minimum cover Fm. The obvious question is what new FDs are added at each x-node. As in Algorithm Propagation of FIG. 1, at each x-node, a new FD Y→I is included into F only if (1) x is keyed with a set of attributes that define the fields in Y; (2) the field I is defined by the value of a node y and y is unique under x.

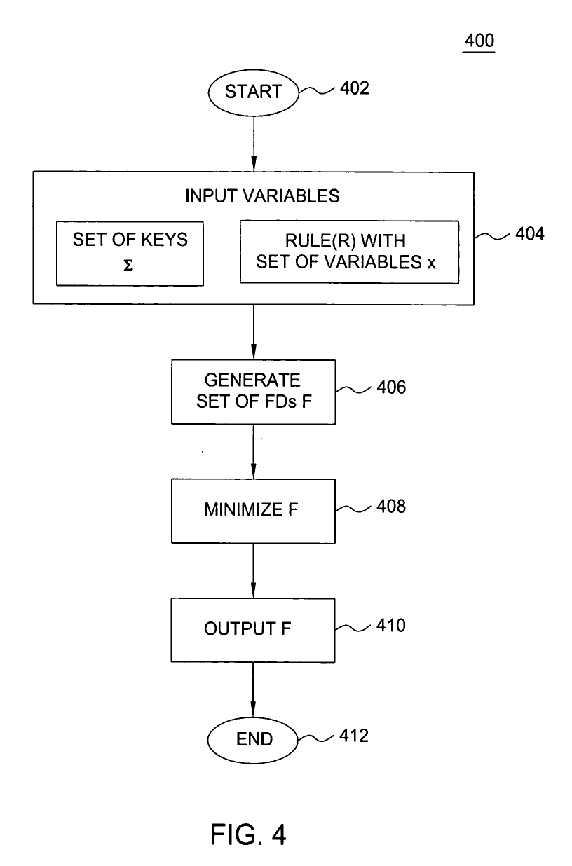

Specifically, the algorithm is depicted in FIG. 4 as a series of method steps 400. The method 400 starts at step 402 and proceeds to step 404 whereby variables are input into the algorithm. These variables are XML-related variables; hence, provide for the basis of XML-based determinations of valid minimum cover Fm not previously considered. In one embodiment of the invention, the variables are selected from the group consisting of a set of XML keys (Σ) and a transformation Rule (R). The set of keys was described earlier in this specification and still applies.

After the variables are input, the method proceeds to step 406 whereby set of FDs (F) are generated (explained in greater detail below) for the given set of XML keys. Once the FDs have been generated, the method proceeds to step 408 where a minimization process is performed on F. Minimization processes are known to those skilled in the art and in one embodiment of the invention, is a process as practiced and disclosed in “Computational Problems Related to the Design of Normal Form Relational Schemas” by C. Beeri and P. A. Bernstein, ACM Trans. On Database System, 4(1):455-469, 1979 although other such algorithms are possible.

Once F is minimized, the method proceeds to step 410 whereby the minimized value of F is outputted. The method ends at step 412.

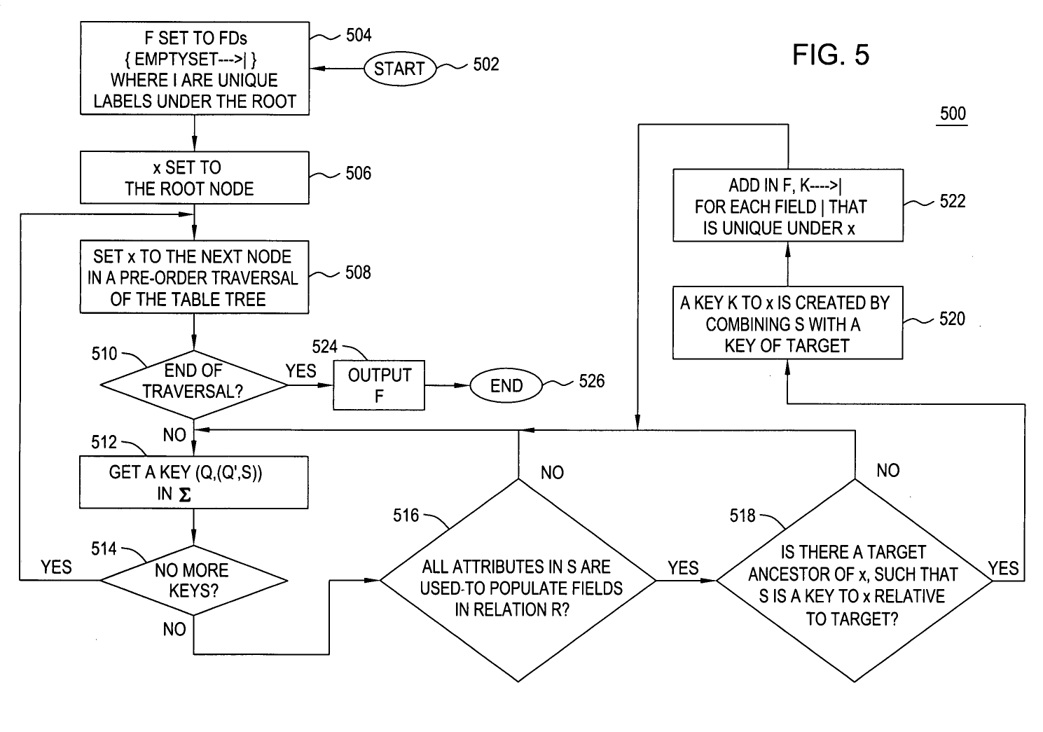

FIG. 5 depicts a series of method steps 500 that details how step 406 of method 400 is performed. Specifically, a set of FDs is generated based upon XML key information and the transformation rule. The method starts at step 502 and proceeds to step 504 where F is initialized with the set of FDs that are to be generated at the root node, consisting of dependencies of the form “emptyset determines I”, form each attribute I that is unique under the root. Next, the method proceeds to step 506 where the value of x (using the Table Tree scenario presented earlier) is set to the root of the Table Tree.

At step 508, the value of x is set to the next node of the Table Tree as a traversal of the entire tree is performed in pre-order traversal (from the root node to each lower node). At step 510, a first decision is made as to whether the traversal process has ended. If the answer to this query is positive, the method 500 proceeds to step 524 where the final value of the FDs, F is output and the method 500 ends at step 526.

If the answer to the query is negative, the method 500 proceeds to step 512 where one of the keys from Σ (see FIG. 4, step 404) is obtained. In this particular example, the Context Path is identified as Q and the Target Path is identified as Q and S is the set of Key Paths. The selection of the key is not critical to the invention as all keys will eventually be checked at the end of the method 500. At step 514, a second decision is made as to whether there are no more keys. If the query is answered positively, the method 500 loops back up to step 508 to evaluate the next node in the Table Tree.

If the query of step 514 is answered negatively, the method 500 proceeds to step 516 where a third decision is made. Since the left hand side of a FD has to correspond to the Key Paths of an XML key, step 516 checks to determine if all of the key path attributes (S) are used to populate fields in a relation (R). If this query is answered negatively, the method 500 proceeds to step 512 to get another key. If the answer to this query is positive, then the method proceeds to step 518 where a fourth decision is made. The decision of step 518 determines if there is a target, ancestor of x, such that S is a key to x relative to Target. That is, the key of the x node may not be relative to the root node, but may be relative to some other ancestor. So it is determined whether x is “keyed” or not and then S is checked to see if it is relative to such ancestor. If the query is answered negatively, the method 500 loops back to step 512 to get another key.

If the query is answered positively, then the method 500 proceeds to step 520 where a new key K is created to x by combining the attributes in S with a key (in one embodiment, the first key is used, but any key is sufficient) of Target. After key creation, the method 500 proceeds to step 522 where a new FD is added to F for each field I that is unique under x. The method then proceeds to loop back to step 512 to check for more keys and eventually comes out of the loop when no more keys are found.

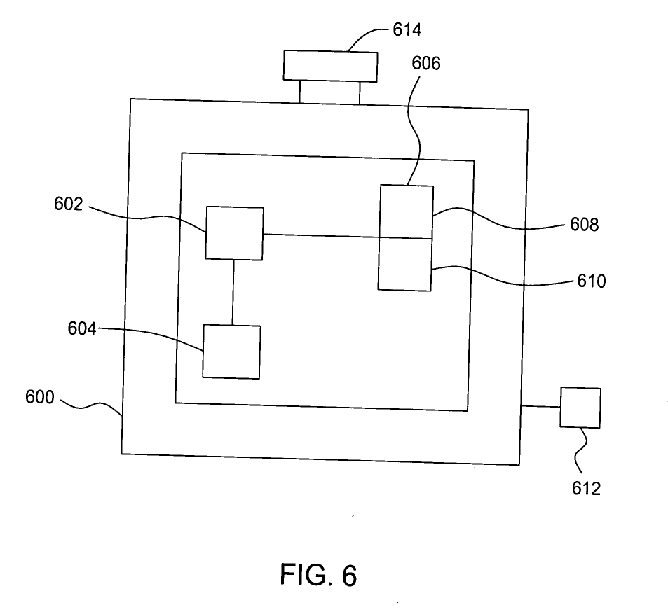

It will be understood and appreciated that each of the methods described herein with respect to all of the above-presented Figures, can be properly written as instruction code in one or more software packages or as ASIC contained within memory of a machine for performing these types of operations. For example, FIG. 6 depicts a general purpose computer 600 that runs such software or contains such ASICs. The computer comprises a central processing unit (CPU) 602, support circuits 604, and memory 606. Other ancillary components such as input devices (i.e., keyboards, mice and the like) 612 and output devices (i.e., displays, printers and the like) 614 are connected to the computer 600. The CPU 602 may comprise one or more conventionally available microprocessors such as a 1.6 GHz Pentium4 processor manufactured and sold by Intel Corporation. The support circuits 604 are well known circuits that comprise power supplies, clocks, input/output interface circuitry and the like. Memory 606 may comprise random access memory, read only memory, removable disk memory, flash memory and various combinations of these types of memory. The memory 606 stores, among other things, various software packages 608 and/or ASICs 610 that dictate functionality and operation of the methods discussed above. As such, the general purpose computer 600 becomes a special purpose machine when executing the steps of validating FDs and/or generating a minimum cover of FDs in accordance with the subject invention.

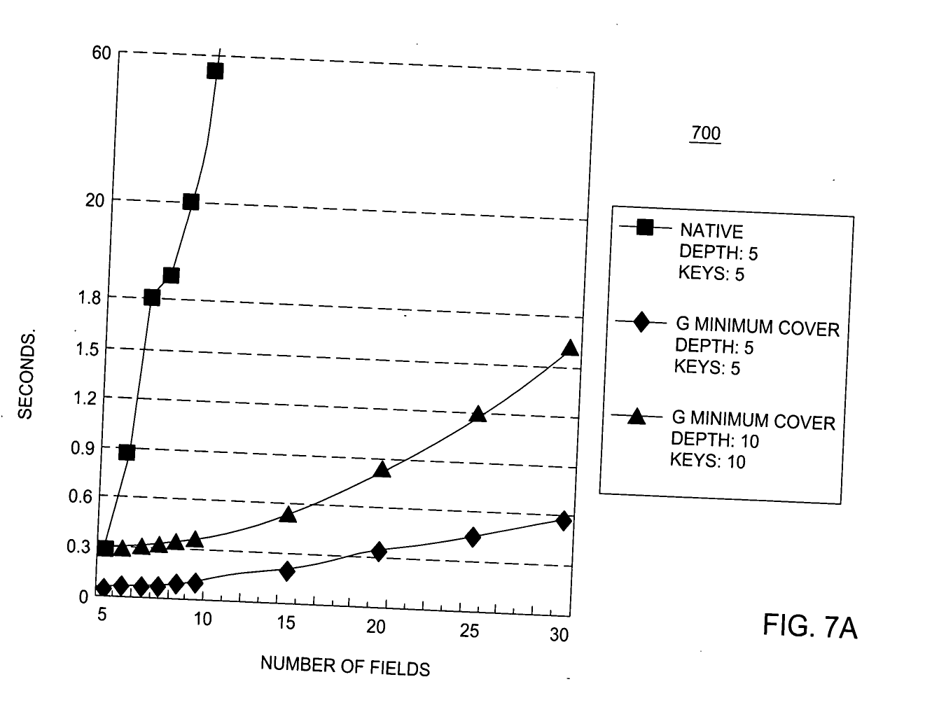

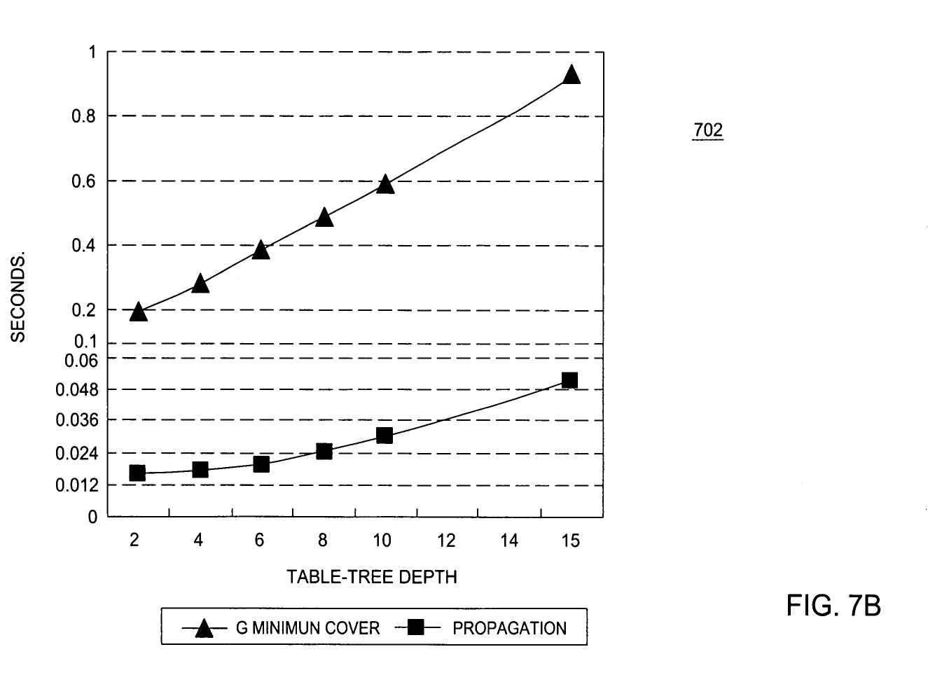

The presented algorithms have been implemented, and a number of experiments performed. The results of these experiments show that the Propagation algorithms of FIGS. 1, 2 and 3 and the MinimumCover algorithms of FIGS. 4 and 5 work well. FIGS. 7a-b depict graphs of the number of fields in the relation table per unit time for various algorithms. For example, when computing minimum cover, algorithm MinimumCover is several orders of magnitude faster than a prior art algorithm (i.e. algorithm Naïve as seen in S. Davidson, W. Fan, C. Hara, and J. Qin. “Propagating XML Constraints to Rrelations”. Technical Report MS-CIS-02-16, University of Pennsylvania, 2002) by inspection of graph 700 of FIG. 7a. The results also reveal that algorithm MinimumCover is more sensitive to the number of XML keys than to the size of the transformation. This is advantageous since in many applications, the number of keys does not change frequently, whereas a relational schema may define tables with a variety of different arities (number of fields).

The second experiment serves two purposes: (1) to compare the effectiveness of these two algorithms for checking key propagation; (2) to study the impact of the depth of table-tree (depth) on the performance of the algorithms. FIG. 7(b) depicts a graph 702 of the execution time of these algorithms when the number of fields in the relational table set to 15 and the number of XML keys is set to 10, with the depth of the transformation's Table tree varying from 2 to 15. The results in FIG. 7(b) reveal a few points. First, algorithm Propagation works well as it takes merely 0.05 second even when the table tree is as deep as 15. Second, these algorithms are rather insensitive to the change to depth. Third, algorithm Propagation is much faster then algorithm GminimumCover for checking key propagation, as expected. Although the actual execution times of the algorithms are quite different, the ratios of increase when the depth of the table-tree grows are similar. Finally, the results also show that Algorithm propagation has a surprisingly low sensitivity to the size of the transformation, and that its execution time grows linearly with the size of XML keys.

Although various embodiments that incorporate the teachings of the present invention have been shown and described in detail herein, those skilled in the art can readily devise many other varied embodiments that still incorporate these teachings.

1. A method for validating the propagation of XML constraints to functional dependencies when transforming XML to relational data, the method comprising:
a) accepting a plurality of variables indicative of XML-based data;
b) determining if one of said plurality of variables is unique when compared to an XML key defining an XML constraint; and
c) determining if one or more fields in said relational data do not have a null value.

2. The method of claim 1 wherein the plurality of variables is selected from the group consisting of a set of XML keys (Σ), a transformation Rule (R) and a Functional Dependency (φ).

3. The method of claim 2 wherein the transformation Rule (R) further comprise an attribute I that corresponds to the value of a variable x.

4. The method of claim 1 wherein the first determining step further comprises:
viewing a transformation Rule as a Table Tree; and
traversing nodes in the Table Tree.

5. The method of claim 4 wherein nodes are traversed until an XML key is found at a particular node and then said one of said plurality of variables is determined to be unique when compared to the context of said XML key.

6. The method of claim 1 wherein the second determining step further comprises:
viewing a transformation Rule as a Table Tree;
traversing nodes in the Table Tree; and
deleting attributes from a set of all attributes that are required to exist as they are found at a particular node when traversing the nodes.

7. A computer readable medium containing a program which, when executed, performs an operation of validating the propagation of XML constraints to functional dependencies when transforming XML to relational data, the operation comprising:
a) accepting a plurality of variables indicative of XML-based data;
b) determining if one of said plurality of variables is unique when compared to an XML key defining an XML constraint; and
c) determining if one or more fields in said relational data do not have a null value.

8. The computer readable medium of claim 7 wherein the plurality of variables is selected from the group consisting of a set of XML keys (Σ), a transformation Rule (R) and a Functional Dependency (φ).

9. The computer readable medium of claim 8 wherein the transformation Rule (R) further comprise an attribute I that corresponds to the value of a variable x.

10. The computer readable medium of claim 7 wherein the first determining step further comprises:
viewing a transformation Rule as a Table Tree; and
traversing nodes in the Table Tree.

11. The computer readable medium of claim 10 wherein nodes are traversed until an XML key is found at a particular node and then said one of said plurality of variables is determined to be unique when compared to the context of said XML key.

12. The computer readable medium of claim 7 wherein the second determining step further comprises:
viewing a transformation Rule as a Table Tree;
traversing nodes in the Table Tree; and
deleting attributes from a set of all attributes that are required to exist as they are found at a particular node when traversing the nodes.
